(19) United States
(12) Patent Application Publication
(10) Pub. No.: US 2020/0331432 A1
(43) Pub. Date: Oct. 22, 2020

(54) DEVICE FOR LOCKING A SPARK-IGNITION ENGINE

(71) Applicant: Jessie CRAMER, Iroquois Falls (CA)

(72) Inventor: Jessie CRAMER, Iroquois Falls (CA)

(21) Appl. No.: 16/852,999

(22) Filed: Apr. 20, 2020

(30) Foreign Application Priority Data
Apr. 18, 2019 (CA) 3040640

(51) Int. Cl. B60R 25/045

(52) U.S. Cl. CPC B60R 25/045

(57) ABSTRACT

The present invention provides for a device configured to lock a spark-ignition engine. The device locks the engine by taking the place of one or more existing spark plugs of the engine and preventing the removal of the device thereof via locking mechanisms. The locking mechanism may operate at its outer end (the locking head) and/or at its inner end (threaded end).

This application claims the benefit of and priority to Canadian Patent Application No. 3,040,640, filed on Apr. 18, 2019, and entitled A DEVICE FOR LOCKING A SPARK-IGNITION ENGINE,” which is hereby incorporated by reference as if fully set forth herein.

### FIELD OF THE DISCLOSURE

The present disclosure generally relates to the field of security or locking devices. In particular embodiments or aspects, the disclosure relates to a device for locking a spark-ignition engine.

### BACKGROUND

A common problem that affects the general population is theft of everyday equipment. More particularly, theft of equipment that operate via a spark-ignition engine, otherwise known as an internal combustion engine. A spark-ignition engine is a common engine used in various equipment including motor vehicles, cars, trucks, motorcycles, ATVs, snowmobiles, personal watercrafts, lawn tractors, boats, golf carts and other similar equipment. Because of the commonality of spark-ignition engines in everyday equipment, a majority of the population have such equipment. As a result, there is a need for preventing the theft of equipment operated by a spark-ignition engine.

The prior art provides various mechanisms for addressing the problem of theft or unauthorized use of devices with spark-ignition engines. Some common theft prevention devices include steering wheel lock, electronic security systems, gear stick locks, and ignition prevention devices. Another example of a theft prevention device is described in Gotto et al., U.S. Pat. No. 4,159,015, titled “Device to Prevent Unauthorized Use of Combustion Engine Driven Vehicles, Ships, Other Equipment”, hereinafter (“Gotto”).

Gotto provides a method and a device to prevent unauthorized use of combustion engine driven vehicles, ships, equipment, as well as engines only including the steps to remove at least one spark plug, to attach a device having an externally threaded part as replacement for the removed spark plug(s), said part having an embracing outside member, which by means of a locking mechanism can be brought into a freely rotatable state in relation to the threaded member, thus preventing removal of same, or, alternatively, bring said members into an interlocked relationship, thus enabling the device to be attached or removed from the engine.

However, the device described in Gotto is complex and consists of various parts that make it hard to manufacture. Particularly, for a device small enough to replace a spark plug, the added complexity may render the design uneconomically to manufacture.

As such, there is a need for an alternative engine lock device that operates by replacing one or more spark plugs of a spark-ignition engine.

### SUMMARY

It is an object of the present disclosure to provide a device for locking a spark-ignition engine.

In accordance with an aspect of the invention, there is provided a device for locking a spark-ignition engine, the device comprising a threaded portion for attaching the device to a spark plug well and one or more locking mechanisms connected to the threaded portion and operable by a key, wherein the locking mechanism is configured to lock the device in the spark-plug well. In an embodiment, the locking mechanism is at the outer end of the device and comprises a locking head connected to the threaded portion. In an embodiment, the locking mechanism locks the device by releasing the locking head from the threaded portion permitting the locking head to rotate freely. In an embodiment, the locking mechanism comprises multi-rotatable locking parts attached to the inner end of the device. In an embodiment, the locking mechanism locks the device by rotating the locking parts outwardly preventing the device from being removed. In an embodiment, the locking mechanism comprises a pinion and multi rack system attached to the inner end of the device. In an embodiment, the locking mechanism locks the device via the pinion moving the racks outwardly preventing the device from being removed. In an embodiment, the locking mechanism comprises a movable multi-armed locking part positioned within the threaded portion. In an embodiment, the locking mechanism locks the device by moving the multi-armed locking part to the inner end of the device and opening the arms of the multi-armed locking part, preventing the device from being removed. In an embodiment, the locking mechanism comprises retractable locking parts attached to the inner end of the device. In an embodiment, the locking mechanism locks the device by opening the retractable locking parts outwardly preventing the device from being removed.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1A is a diagram of an engine lock device in accordance with an embodiment of the present disclosure;

FIG. 1B is the top view of the engine lock device of FIG. 1A in accordance with an embodiment of the present disclosure;

FIG. 2A is a diagram of an engine lock device with a locking mechanism at the inner end of the device comprising multiple rotatable locking parts in accordance with an embodiment of the present disclosure;

FIG. 2B is the bottom view of the engine lock device of FIG. 2A in accordance with an embodiment of the present disclosure;

FIG. 3A is a diagram of an engine lock device with a locking mechanism at the inner end of the device comprising a pinion and rack system in accordance with an embodiment of the present disclosure;

FIG. 3B is a bottom view of the engine lock device of FIG. 3A in accordance with an embodiment of the present disclosure;

FIG. 4A is a diagram of an engine lock device with a locking mechanism at the inner end of the device comprising movable multi-armed locking part in accordance with an embodiment of the present disclosure;

FIG. 4B is the bottom view of the engine lock device of FIG. 4A wherein the device is in a locked state in accordance with an embodiment of the present disclosure;

FIG. 5A is a diagram of an engine lock device with a locking mechanism at the inner end of the device comprising retractable locking parts in accordance with an embodiment of the present disclosure;

FIG. 5B is bottom view of the engine lock device of FIG. 5A in accordance with an embodiment of the present disclosure;

FIG. 6A is a diagram of an engine lock device with a locking mechanism at the locking head or the outer end of the device comprising a locking head in accordance with an embodiment of the present disclosure;

FIG. 6B is an intersectional view of the engine lock device of FIG. 6A comprising a ratchet mechanism, where the locking head is engaged with the threaded portion and cannot rotate freely, in accordance with an embodiment of the present disclosure;

FIG. 6C is an intersectional view of the engine lock device of FIG. 6A comprising a ratchet mechanism, where the locking head is disengaged from the threaded portion and can rotate freely, in accordance with an embodiment of the present disclosure;

FIG. 7A is an intersectional view of the engine lock device of FIG. 6A in an unlocked state comprising a pinion and multi rack system in accordance with an embodiment of the present disclosure;

FIG. 7B is an intersectional view of the engine lock device of FIG. 6A in a locked state comprising a pinion and multi rack system in accordance with an embodiment of the present disclosure

FIG. 8A is a diagram of an engine lock device in a locked state comprising a locking gear mechanism in accordance with an embodiment of the present disclosure;

FIG. 8B is a diagram of an engine lock device in an unlocked state comprising a locking gear mechanism in accordance with an embodiment of the present disclosure;

### DETAILED DESCRIPTION

The present disclosure provides for a compact security device for a spark plug well of a spark-ignition engine. The device may be used in equipment operating via a spark-ignition engine, for example, motor vehicles, cars, trucks, motorcycles, ATVs, snowmobiles, personal watercrafts, lawn tractors, boats and other similar equipment. The device is configured to prevent anyone from removing the device from the engine without a key.

By preventing the spark in one cylinder, the engine is unable to operate smoothly or properly, rendering the engine useless. Any attempt to remove the device by a drill or other tools would potentially damage the engine since metal filings could drop into the cylinder and score the piston-cylinder surface.

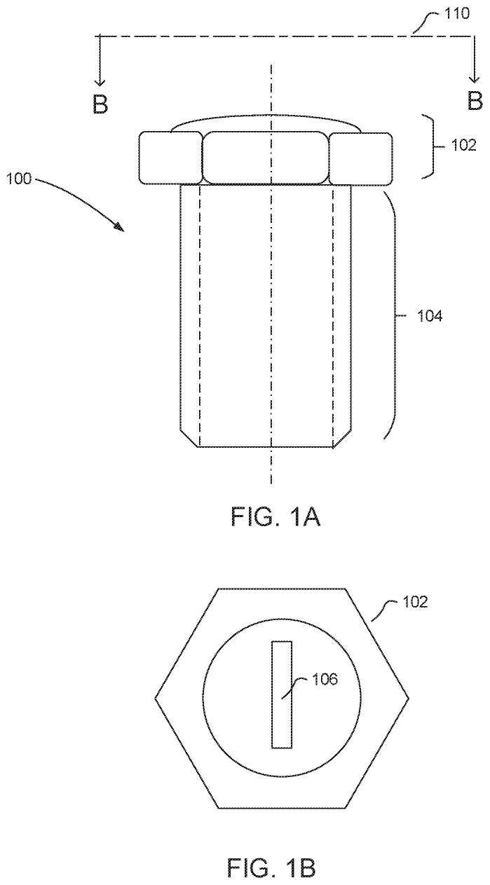

Referring to FIGS. 1A and 1B (view from B-B 110), the device 100 is generally similar in size and shape to a spark plug. The device 100 contains a head portion 102 and a threaded portion 104. The head portion 102, which is the outer exposed portion or outer end of the device 100, contains a keyhole 106 for insertion of a key operating the device 100. The head portion 102 may be dome-shaped to prevent socket application. Alternatively, the head portion 102 of the device 100 may be designed to permit only (a) special tool(s) (not shown) to be used for attaching and removing the device 100 to and from the spark plug well.

The threaded portion 104 is attached to a spark plug well of an engine by screwing the device into the spark plug well, after removing the existing spark plug. Alternatively, for further convenience, the device is configured as a “drop-in” style (not shown).

In some embodiments, the device 100 is manufactured from hardened steel to resist breaking and tampering. The primary components are optionally may be cast to shape, precision machined as needed, hardened, and then assembled. In some embodiments, the device 100 is equipped with a tracking system for the equipment, including a Global Positioning System (GPS) tracking system and GPS tracking system with real time.

The device 100 contains a locking mechanism for locking the device 100 into a spark plug well. The locking mechanism may operate at either end or both ends, (the inner end (threaded end) and/or the outer end (at the locking head 102)), of the device 100. The inner end of the device 100 refers to the end inside the cylinder, and the outer end of the device refers to end outside of the cylinder.

The locking mechanism may operate at the threaded or the inner end of the device 100 by preventing the device from being removed. For example, the threaded end or the inner end of the device 100 may become locked at the spark plug well within the cylinder of the engine by various locking mechanism, for example, multi-rotatable locking parts, a pinion and multi rack system, a movable multi-armed locking part, or retractable locking parts.

To use the device, an equipment owner may select an easily accessible spark plug and remove the spark plug from the engine. The owner then inserts the device 100 into the empty spark plug well. The device 100 is screwed into the spark plug well, and once secured, a key is inserted in the keyhole 106 and turned to operate the various embodiments of the locking mechanisms in the present disclosure.

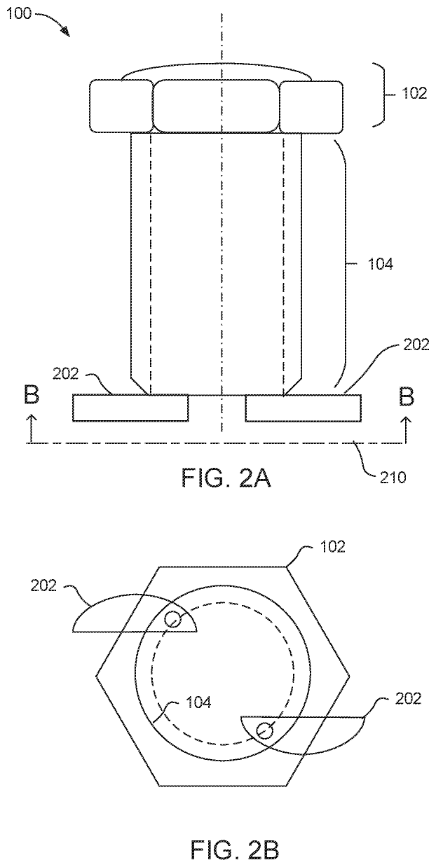

An embodiment of the present disclosure provides for a locking mechanism at the inner end of the device 100. Referring to FIGS. 2A and FIG. 2B (view from bottom 210), the locking mechanism of the device 100 comprises multiple pivoting or rotatable locking parts 202 attached to the inner end of the device 100.

Upon turning the key, the rotatable locking parts 202 open or rotate outwardly preventing the device 100 from being unscrewed or removed from the spark plug well. At this state (FIGS. 2A and 2B), the rotatable locking parts 202 are in a locked position thereby locking the device in place. The rotatable locking parts 202 maintain their locked position until the equipment owner unlocks the device 100 by inserting the key in the keyhole 106 and turning the key. Upon unlocking the device, the rotatable locking parts 202 close or rotate inwardly to their original position, the unlocked position, permitting the device 100 to be removed from the spark plug well.

Various methods known in the art may be used to operate the rotatable locking parts 202 disclosed herein.

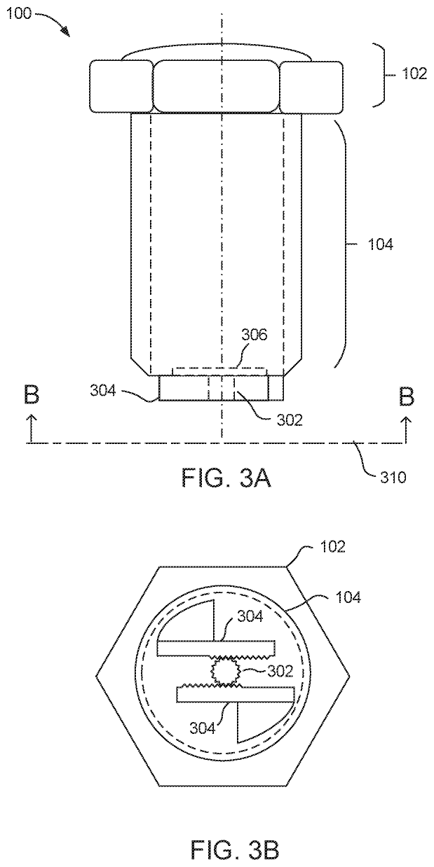

Another embodiment of the present disclosure provides for a locking mechanism comprising a pinion and multi rack system attached to the inner end of the device 100. Referring to FIGS. 3A and 3B (view from bottom, B-B 310), the locking mechanism comprises a pinion 302 and one or more racks 304. Upon turning the key, the pinion 302, which at all time is engaged with the racks 304, causes the racks to move outwardly or in opposite directions. As the racks 304 are caused to move, the racks 304 slide within grooves 306, limiting the extent of movement. Once the racks 304 are moved such that the device is prevented from being unscrewed or removed, the racks 304 and/or device 100 are/is in a locked position. The racks 304 maintain their locked position until the equipment owner unlocks the device 100 by inserting the key in the keyhole 106 and turning the key. Upon unlocking the device, the pinion 302 causes the racks 304 to move inwardly in their original position, unlocked position (FIGS. 3A and 3B), permitting the device 100 to be removed from the spark plug well.

Various methods known in the art may be used to operate the pinion and multi rack system disclosed herein.

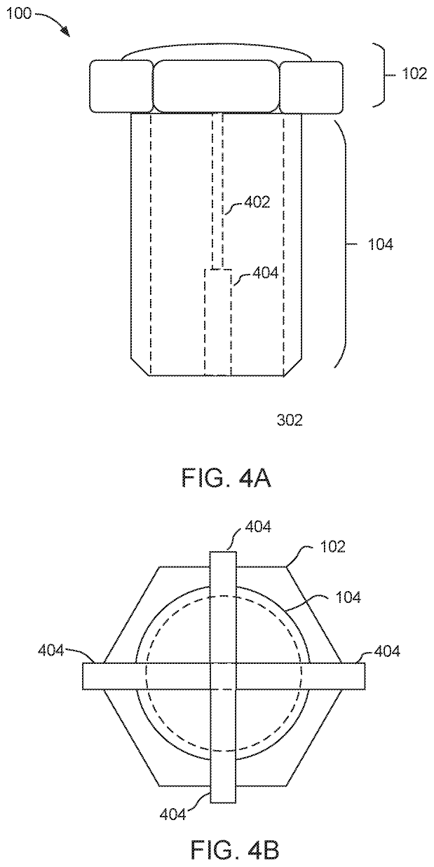

Another embodiment of the present disclosure provides for a locking mechanism comprising a movable multi-armed locking part. Referring to FIG. 4A, the locking mechanism comprising a movable multi-armed locking part 402 is positioned within the threaded portion 104 of the device 100.

Referring to FIGS. 4A and 4B (where FIG. 4B is the view from the bottom when device is at a locked position according to an embodiment of the present disclosure), upon turning the key, the movable multi-armed locking part 402 is moved toward the inner end of the device 100, and upon reaching the inner end, the arms 404 of the movable multi-armed locking part 402 are opened in a locked position (FIG. 4B), preventing the device 100 from being removed. The arms 404 maintain their locked position until the key is turned again, which causes the movable multi-armed locking part 402 to close its arms 404 and move toward the outer end, away from the inner end of the device 100, into an unlocked position (refer to FIG. 4A).

Various methods known in the art may be used to operate the movable multi-armed locking part 402 disclosed herein.

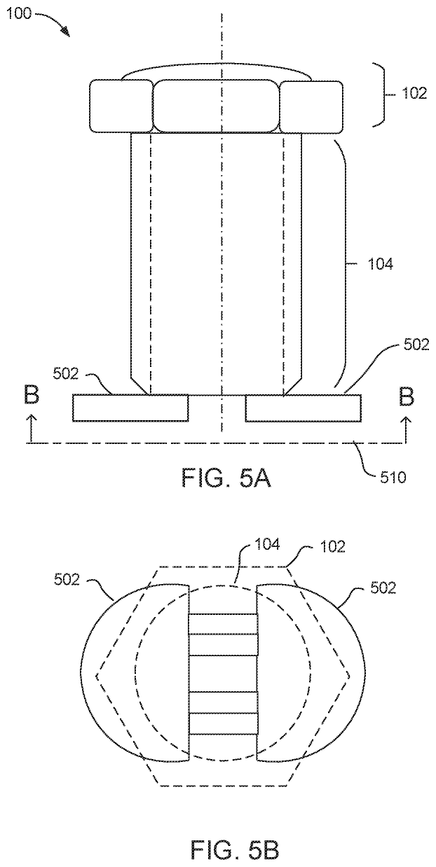

According to an embodiment of the present disclosure, a locking mechanism comprising retractable locking parts is used to lock the device 100 at the inner end of the device 100. Referring to FIGS. 5A and FIG. 5B (where FIG. 5B is the view from bottom 510), the retractable locking parts 502 is attached to the inner end of the device 100.

Upon turning the key, the retractable locking parts 502 are caused to open and move outwardly, preventing the device from being unscrewed and/or removed from the spark plug well. At this state, as shown in FIGS. 5A and 5B, the retractable locking parts 502 are in a locked position as the device 100 cannot be removed or unscrewed from the spark plug well.

The device 100 remains in the locked position until the key is turned again to unlock the device. Upon turning the key, the retractable locking parts 502 are caused to close and move inwardly back to their original position. At this state, retractable locking parts 502 are in an unlocked position and the device may be unscrewed and/or removed from the spark plug well.

Various methods known in the art may be used to operate the retractable locking parts 502 disclosed herein.

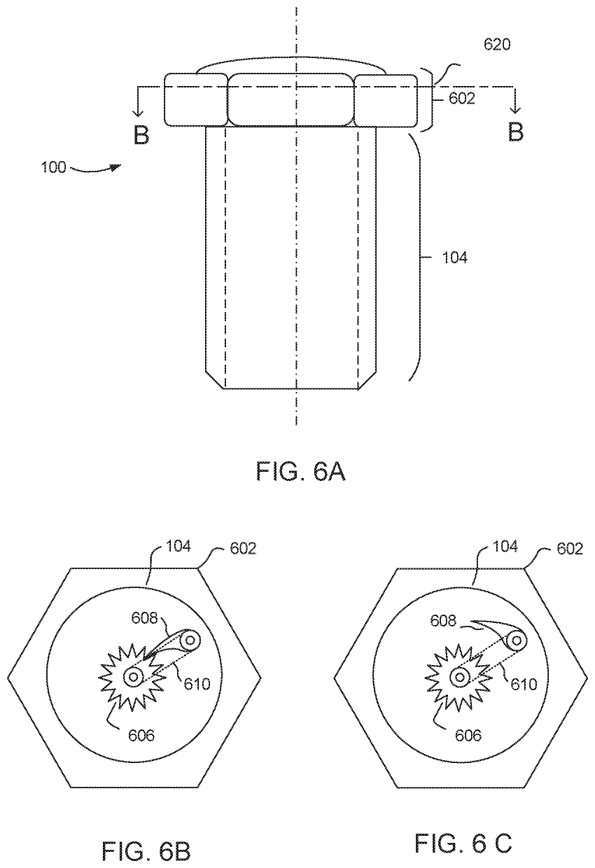

Referring to FIG. 6A, another embodiment of the present disclosure provides for a locking mechanism comprising a locking head 602 (also be the head portion 102) of the device 100.

Upon turning the key, the locking head 602 is disengaged or released from the threaded portion 104 of the device 100, taking on a locked position. When the locking head 602 is released from the threaded portion 104, the locking head 602 is free to rotate about the threaded portion, which prevents the device 100 from being unscrewed or removed from the spark plug well. The locking head remains in the locked position until the key is turned again, which re-engages the locking head 602 with the threaded portion 104, into an unlocked position. While in the unlocked position, the locking head 602 cannot rotate freely about the threaded portion 104 of the device 100, which permits the device 100 to be unscrewed or removed from the spark plug well.

Various methods known in the art may be used to operate the locking head 602 disclosed herein.

According to an embodiment of the present disclosure, a ratchet mechanism is used to operate the locking head 602 of the device 100. Referring to FIG. 6B (view from B-B intersection 620), the ratchet mechanism comprises a gear-like part 606, for example a ratchet wheel, a pivoting part 608, for example a pawl, and a linking part 610. The gear part 606 is fixed to the threaded portion 104 of the device 100. The pivoting part 608 is connected to the linking part 610 which is fixed to the locking head 602.

FIG. 6C is an intersectional view of the engine lock device of FIG. 6A from B-B intersection 620, where the locking head 602 is disengaged from the threaded portion 104 and can rotate freely. Referring to FIG. 6C (view from B-B intersection 620), upon turning the key, the linking part 610 releases the locking head 602 from the threaded portion 104 by pivoting or rotating the pivoting part 608 away from the gear part 606. Since the pivoting part 608 is fixed to the locking head 602 and the gear part 606 is fixed to the threaded portion 104, when the pivoting part 608 is disengaged from the gear part 606, the locking head 602 can rotate freely on its own. So, when the pivoting part 608 is disengaged the gear part 606, any attempt at unscrewing the device 100 is ineffective as the locking head will just rotate on its own without rotating or unscrewing the threaded portion 104 from the spark plug well.

The locking head 602 remains in its disengaged or released position until the key is turned again to unlock the device 100. Referring to FIG. 6B, upon turning the key, the linking part 610 re-engages the locking head 602 to the threaded portion 104 by pivoting or rotating the pivoting part 608 toward the gear part 606 to engage the pivoting part 608 with the gear part 606. Once the pivoting part 608 is engaged with the gear part 606, the locking head 602 is fixed with the threaded portion 104 and cannot rotate freely on its own, permitting the device 100 to be unscrewed and/or removed from the spark plug well.

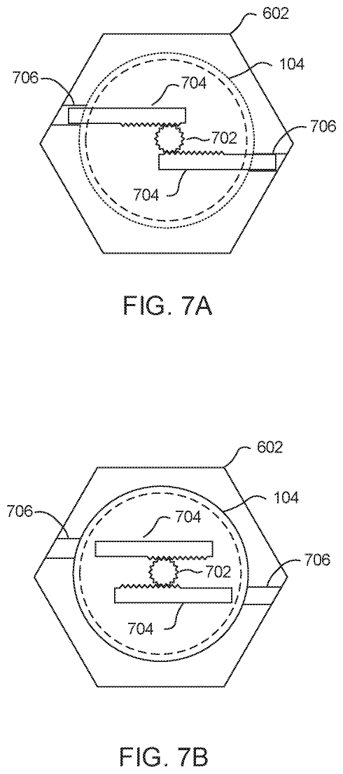

According to an embodiment of the present disclosure, a pinion and multi rack/pin system is used to operate the locking head 602 of the device 100. Referring to FIG. 7A (viewed from intersection B-B 620) the pinion and rack system comprises a pinion 702 and one or more racks/pins 704 attached to the threaded portion 104 of the device 100. The locking head 602 contains one or more grooves 706 to be filled by the racks/pins 704. For illustrative purposes, FIG. 7A only shows two grooves 706, however, the locking 602 head may have any number of grooves 706 to permit the pinion and multi rack/pin system operate efficiently.

Referring to FIG. 7B, upon turning the key, the pinion 702 is also turned causing the racks/pins 704 to retract inwardly emptying the grooves 706. This releases or disengages the locking head 602 from the threaded portion 104 and permits the locking head 602 to rotate freely about the threaded portion 104. The device 100 and/or the locking head 602 is now at a locked position (FIG. 7B) because any attempt at unscrewing the device will be ineffective since the locking head 602 can rotate freely.

The locking head 602 remains in its locked or released position (FIG. 7B) until the key is turned again to unlock the device 100. Referring to FIG. 7A, upon turning the key, the pinion 702 is also turned causing the racks/pins 704 to extend outwardly into the grooves 706, engaging the locking head 602 to the threaded portion 104. At this state, the locking head 602 cannot rotate freely about the threaded portion 104 and can only rotate with the threaded portion 104. At this state, the device 100 and/or the locking head 602 are/is now at an unlocked position (FIG. 7A) because the device 100 may be unscrewed and/or removed from the spark plug well.

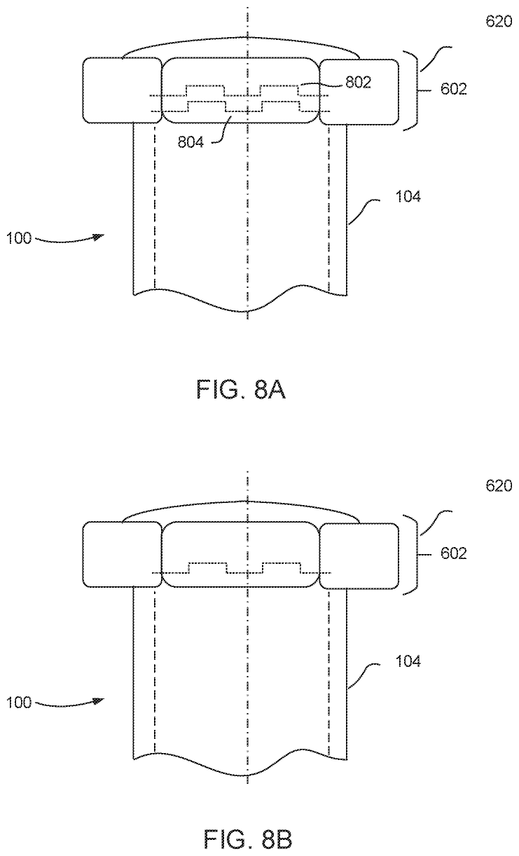

According to an embodiment of the present disclosure, a locking gear mechanism is used to operate the locking head 602 of the device 100. Referring to FIG. 8A, the locking head 602 comprises a geared section 802 with a matching geared pattern as that of a geared section 804 of the threaded portion 104.

Upon turning the key, the locking head's geared section 802 is moved away from the geared section 804 of the threaded portion 104, disengaging and/or releasing the locking 602 from the threaded portion 104. At this state (FIG. 8A), the locking head 602 is in a locked position and free to rotate about its centre. Any attempt at unscrewing and/or removing the device while the locking head 602 is in a locked position is ineffective as the locking head 602 can rotate freely.

The locking head 602 remains in its locked or released position until the key is turned again to unlock the device 100. Referring to FIG. 8B, upon turning the key, the locking head's geared section 802 is moved toward the geared section 804 of the threaded portion 104, re-engaging the two geared sections 802 and 804, and thereby engaging the locking head 602 to the threaded portion 104. At this state (FIG. 8B), the locking head 602 is in an unlocked position and the device may be unscrewed and/or removed from the spark plug well.

Directional terms such as “inward” and “downward”, “left” and “right” are used to refer to directions in the drawings to which reference is made unless otherwise stated. Moreover, all representations described herein are intended solely to be by way of example for purposes of illustrating certain embodiments and are not intended to limit the scope of the disclosure to any embodiments that may depart from such representation as may be described.

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The structure, manufacture and use of the presently disclosed embodiments have been discussed above. While example embodiments are disclosed, this is not intended to be limiting the scope of the presently described embodiments. It should be appreciated, however that the present disclosure, which is described by the claims and not by the implementation details provided, which can be modified by omitting, adding or replacing elements with equivalent functional elements, provides many applicable inventive concepts that may be embodied in a wide variety of specific contexts. The specific embodiments discussed are merely illustrative of specific ways to make and use the disclosure, and do not limit the scope of the present disclosure. Rather, the general principles set forth herein are considered to be merely illustrative of the scope of the present disclosure.

In particular, features from one or more of the above-described embodiments may be selected to create alternative embodiments comprised of a sub-combination of features that may not be explicitly described above. In addition, features from one or more of the above-described embodiments may be selected and combined to create alternative embodiments comprised of a combination of features that may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

It will be apparent that various modifications and variations covering alternatives, modifications and equivalents will be apparent to persons having ordinary skill in the relevant art upon reference to this description and may be made to the embodiments disclosed herein, without departing from the present disclosure, as defined by the appended claims.

Other embodiments consistent with the present disclosure will be apparent from consideration of the specification and the practice of the disclosure disclosed therein. Accordingly the specification and the embodiments disclosed therein are to be considered examples only, with a true scope of the disclosure being disclosed by the following numbered claims.

We claim:

1. A device for locking a spark-ignition engine, the device comprising:
a threaded portion for attaching the device to a spark plug well; and
one or more locking mechanisms connected to the threaded portion and operable by a key, wherein the locking mechanism is configured to lock the device in the spark-plug well.

2. The device of claim 1, wherein the locking mechanism is at the outer end of the device and comprises a locking head connected to the threaded portion.

3. The device of claim 2, wherein the locking mechanism locks the device by releasing the locking head from the threaded portion permitting the locking head to rotate freely.

4. The device of claim 1, wherein the locking mechanism comprises multi-rotatable locking parts attached to the inner end of the device.

5. The device of claim 4, wherein the locking mechanism locks the device by rotating the locking parts outwardly preventing the device from being removed.

6. The device of claim 1 wherein the locking mechanism comprises a pinion and multi rack system attached to the inner end of the device.

7. The device of claim 6, wherein the locking mechanism locks the device via the pinion moving the racks outwardly preventing the device from being removed.

8. The device of claim 1, wherein the locking mechanism comprises a movable multi-armed locking part positioned within the threaded portion.

9. The device of claim 8, wherein the locking mechanism locks the device by moving the multi-armed locking part to the inner end of the device and opening the arms of the multi-armed locking part, preventing the device from being removed.

10. The device of claim 1, wherein the locking mechanism comprises retractable locking parts attached to the inner end of the device.

11. The device of claim 10, wherein the locking mechanism locks the device by opening the retractable locking parts outwardly preventing the device from being removed.
